(19) United States
(12) Patent Application Publication
(10) Pub. No.: US 2017/0274544 A1
(43) Pub. Date: Sep. 28, 2017

(54) Cutting Tool

(71) Applicants: Ty Stiles, Turlock, CA (US); Merri Stiles, Turlock, CA (US)

(72) Inventors: Ty Stiles, Turlock, CA (US); Merri Stiles, Turlock, CA (US)

(21) Appl. No.: 15/079,369

(22) Filed: Mar. 24, 2016

(51) Int. Cl. B26B 27/00; B25G 1/10; B26B 29/02

(52) U.S. Cl. CPC B26B 27/005; B26B 29/02; B25G 1/102

(57) ABSTRACT

An cutting tool for accessing plastic containers includes a head coupled to a first end of a handle. The head extends transversely from the first end past a front of the handle defining a nose of the head. A blade is coupled to and extends from a lower edge of the nose. A cover is hingedly coupled to the handle proximate to the first end. The cover is complementary to the head, such that the head is insertable into the cover with a lower limit of the cover extending past the blade. A biaser is operationally coupled to the cover. The biaser is positioned to motivate the cover to a closed position such that the blade is not exposed.

### BACKGROUND OF THE DISCLOSURE

### Field of the Disclosure

The disclosure relates to cutting tools and more particularly pertains to a new cutting tool for accessing plastic containers.

### SUMMARY OF THE DISCLOSURE

An embodiment of the disclosure meets the needs presented above by generally comprising a head coupled to a first end of a handle. The head extends transversely from the first end past a front of the handle defining a nose of the head. A blade is coupled to and extends from a lower edge of the nose. A cover is hingedly coupled to the handle proximate to the first end. The cover is complementary to the head, such that the head is insertable into the cover with a lower limit of the cover extending past the blade. A biaser is operationally coupled to the cover. The biaser is positioned to motivate the cover to a closed position such that the blade is not exposed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of an cutting tool according to an embodiment of the disclosure.

FIG. 2 is a side view of an embodiment of the disclosure.

FIG. 3 is a side view of an embodiment of the disclosure.

FIG. 4 is a cross-sectional view of an embodiment of the disclosure.

FIG. 5 is a cross-sectional view of an embodiment of the disclosure.

### DESCRIPTION OF THE PREFERRED EMBODIMENT

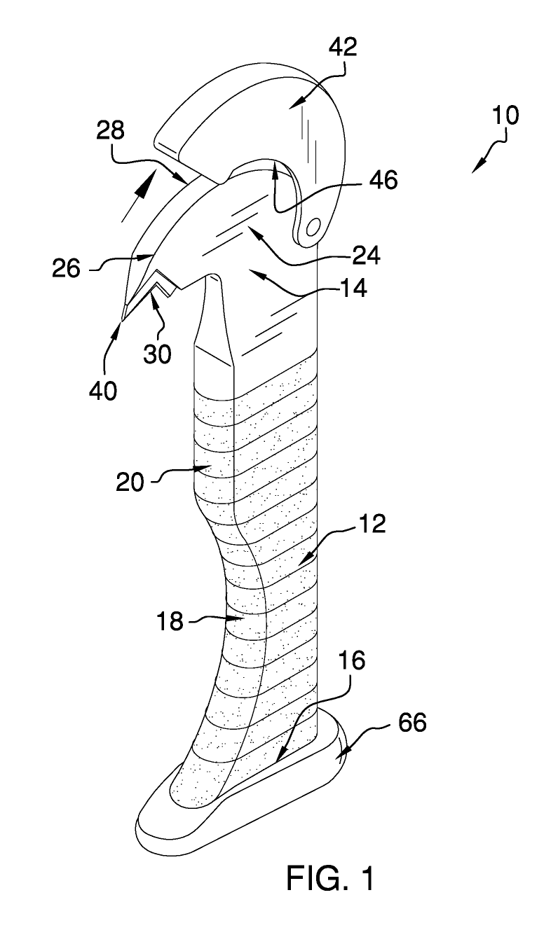

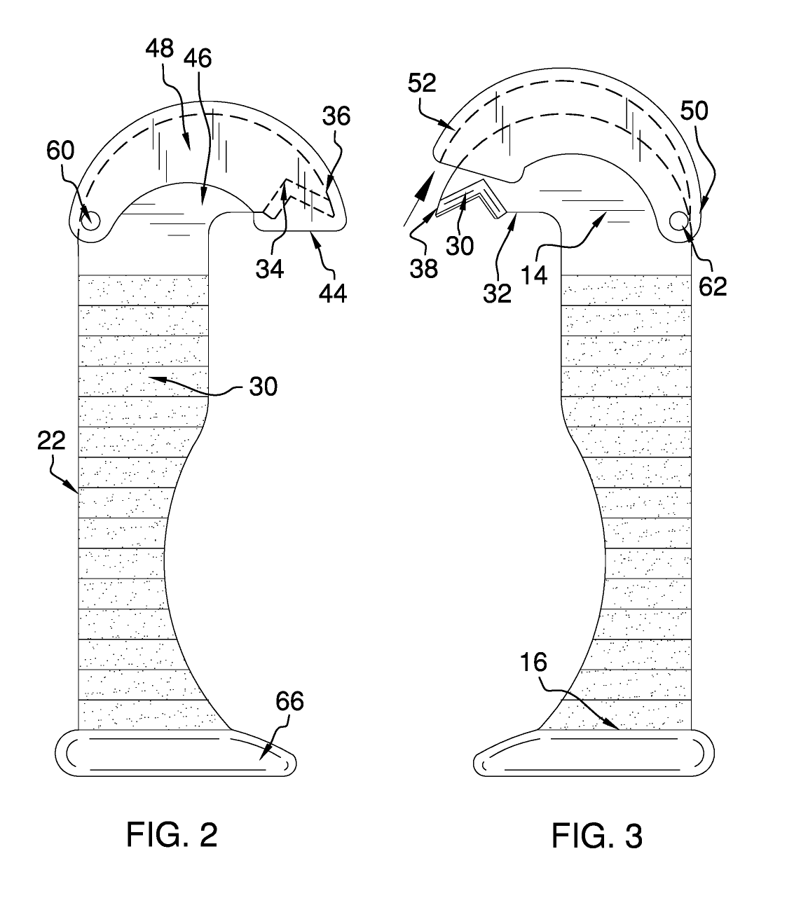

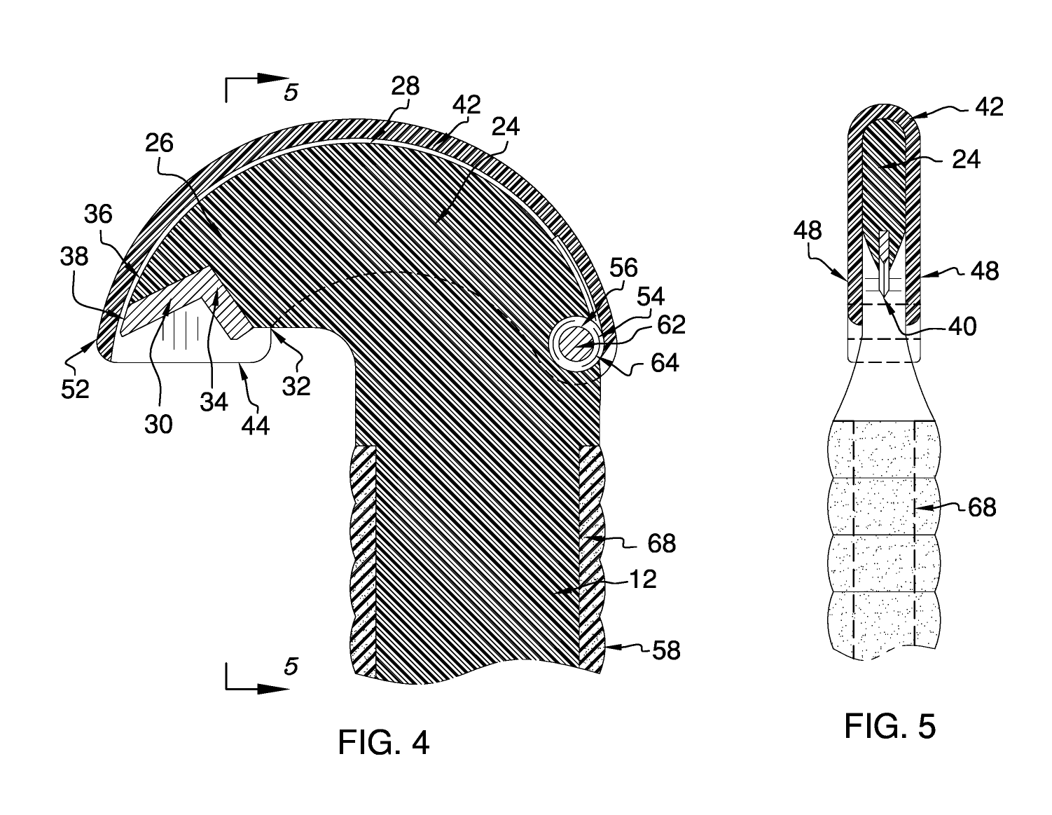

With reference now to the drawings, and in particular to FIGS. 1 through 5 thereof, a new cutting tool embodying the principles and concepts of an embodiment of the disclosure and generally designated by the reference numeral 10 will be described.

As best illustrated in FIGS. 1 through 5, the cutting tool 10 generally comprises a handle 12. The handle 12 is substantially elongated rectangularly box shaped. The handle 12 is tapered proximate to a first end 14 of the handle 12, such that the first end 14 of the handle 12 is dimensionally smaller than a second end 16 of the handle 12. An indentation 18 is positioned in a front 20 of the handle 12. The indentation 18 is positioned in the handle 12 such that the indentation 18 is configured to receive the fingers of a user's hand to facilitate grasping of the handle 12. Preferably, the indentation 18 is arcuate and extends from proximate to the second end 16 of the handle 12 to proximate to a midpoint 22 of the handle 12.

A head 24 is coupled to the first end 14 of the handle 12. The head 24 extends transversely from the first end 14 past the front 20 of the handle 12, defining a nose 26 of the head 24. The head 24 has a top 28, which preferably is arcuate. A blade 30 is coupled to and extends from a lower edge 32 of the nose 26. Preferably, a notch 34 is positioned upwardly into the lower edge 32 of the nose 26. The notch 34 is positioned adjacent to a front face 36 of the head 24. Preferably, the notch 34 is V shaped. The blade 30 is complementary to and coupled within the notch 34.

The front face 36 of the head 24 is tapered proximate to the lower edge 32 of the nose 26. Preferably, the blade 30 comprises a front cutting edge 38 that defines a puncture tip 40 positioned proximate to the lower edge 32 of the nose 26 and the front face 36 of the head 24.

A cover 42 is hingedly coupled to the handle 12 proximate to the first end 14. The cover 42 is complementary to the head 24. The head 24 is insertable into the cover 42 with a lower limit 44 of the cover 42 extending past the blade 30. Each of a pair of cutouts 46 is positioned in a respective opposing wall 48 of the cover 42. Preferably, the cutouts 46 are arcuate. Also preferably, each cutout 46 is positioned in a respective opposing wall 48 adjacent to the lower limit 44 of the cover 42 and substantially equally distant from a back end 50 and a front end 52 of the cover 42.

A biaser 54 is operationally coupled to the cover 42. The biaser 54 is positioned to motivate the cover 42 to a closed position such that the blade 30 is not exposed. A channel 56 extends through the handle 12 proximate to the first end 14 and a back 58 of the handle 12. Each of a pair of penetrations 60 is positioned through a respective opposing wall 48 of the cover 42 proximate to the back end 50 of the cover 42. The penetrations 60 are complementary to the channel 56. A pin 62, complementary to and positioned through the channel 56 and the pair of penetration 60, hingedly couples the cover 42 to the head 24.

Preferably, the biaser 54 comprises a torsion spring 64 positioned in the channel 56 and coupled to the pin 62. The cover 42 is positioned such that opening of the cover 42 rotates the pin 62 and induces torsion in the torsion spring 64. The torsion spring 64 is motivated to return the cover 42 to a closed position wherein the cover 42 is positioned with the lower limit 44 of the cover 42 extending past the lower edge 32 of the nose 26.

Preferably, a stop 66 is coupled to the second end 16 of the handle 12. The stop 66 is positioned on the handle 12 to deter slippage of the user's hand from the handle 12. Also preferably, a grip 68 is coupled to the handle 12. The grip 68 extends from the second end 16 to proximate to the first end 14 of the handle 12. The grip 68 is positioned on the handle 12 to facilitate grasping of the handle 12 in the user's hand. Preferably, the grip 68 comprises rubber and is textured.

In use, the handle 12 is configured for grasping in the user's hand, with the indentation 18 and the grip 68 positioned on the handle 12 to facilitate grasping of the handle. The cover 42 is configured to rotate relative to the head 24 when a plastic container is positioned against the lower limit 44 of the cover 42. Rotation of the cover 42 positions the puncture tip 40 to penetrate the plastic container. The blade 30 is positioned in the notch 34 such that the plastic container is openable by movement of the handle 12 relative to the plastic container. The torsion spring 64 is positioned in the channel 56 such that opening of the cover 42 induces torsion in the torsion spring 64. Upon abatement of the opening force imparted by contact of the lower limit 44 of the cover 42 with the plastic container, the torsion spring 64 motivates the cover 42 into a closed position with the lower limit 44 of the cover 42 extending past the lower edge 32 of the nose 32, thereby covering the blade 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An cutting tool comprising:
a head coupled to a first end of a handle, said head extending transversely from said first end past a front of said handle defining a nose of said head;
a blade coupled to and extending from a lower edge of said nose;
a cover hingedly coupled to said handle proximate to said first end, said cover being complementary to said head, wherein said head is insertable into said cover with a lower limit of said cover extending past said blade; and
a biaser operationally coupled to said cover, wherein said biaser is positioned to motivate said cover to a closed position such that said blade is not exposed.

2. The tool of claim 1, further including said handle being substantially elongated rectangularly box shaped.

3. The tool of claim 1, further including said handle being tapered proximate to said first end of said handle, such that said first end of said handle is dimensionally smaller than a second end of said handle.

4. The tool of claim 1, further including an indentation positioned in said front of said handle, wherein said indentation is positioned in said handle such that said indentation is configured to receive the fingers of a user's hand to facilitate grasping of said handle.

5. The tool of claim 4, further including said indentation extending from proximate to a second end of said handle to proximate to a midpoint of said handle.

6. The tool of claim 4, further including said indentation being arcuate.

7. The tool of claim 1, further including said head having a top, said top being arcuate.

8. The tool of claim 1, further including a notch positioned upwardly into said lower edge of said nose, said notch being positioned adjacent to a front face of said head, said blade being complementary to and coupled within said notch.

9. The tool of claim 8, further including said notch being V shaped.

10. The tool of claim 9, further including said front face of said head being tapered proximate to said lower edge of said nose.

11. The tool of claim 10, further including said blade comprising a front cutting edge defining a puncture tip positioned proximate to said lower edge of said nose and said front face of said head.

12. The tool of claim 1, further including a pair of cutouts, each said cutout being positioned in a respective opposing wall of said cover.

13. The tool of claim 12, further including said cutouts being arcuate, each said cutout being positioned in a respective said opposing wall adjacent to said lower limit of said cover and substantially equally distant from a back end and a front end of said cover.

14. The tool of claim 13, further including a channel extending through said handle proximate to said first end and a back of said handle;
a pair of penetrations, each said penetration being positioned through a respective said opposing wall of said cover proximate to said back end of said cover, said penetrations being complementary to said channel;
a pin complementary to and positioned through said channel and said pair of penetrations, wherein said cover is hingedly coupled to said head;
said biaser comprising a torsion spring positioned in said channel and coupled to said pin; and
wherein said cover is positioned such that opening of said cover rotates said pin and induces torsion in said torsion spring such that said torsion spring is motivated to return said cover to a closed position wherein said cover is positioned with said lower limit of said cover extending past said lower edge of said nose.

15. The tool of claim 1, further including a stop coupled to a second end of said handle, wherein said stop is positioned on said handle to deter slippage of a user's hand from said handle.

16. The tool of claim 1, further including a grip coupled to said handle, said grip extending from a second end to proximate to said first end of said handle, wherein said grip is positioned on said handle to facilitate grasping of said handle in the user's hand.

17. The tool of claim 16, further including said grip comprising rubber.

18. The tool of claim 16, further including said grip being textured.

19. An cutting tool comprising:
a handle, said handle being substantially elongated rectangularly box shaped, said handle being tapered proximate to a first end of said handle, such that said first end of said handle is dimensionally smaller than a second end of said handle;
an indentation positioned in a front of said handle, wherein said indentation is positioned in said handle such that said indentation is configured to receive the fingers of a user's hand to facilitate grasping of said handle, said indentation extending from proximate to said second end of said handle to proximate to a midpoint of said handle, said indentation being arcuate;
a head coupled to said first end of said handle, said head extending transversely from said first end past said front of said handle defining a nose of said head, said head having a top, said top being arcuate;
a blade coupled to and extending from a lower edge of said nose,
a notch positioned upwardly into said lower edge of said nose, said notch being positioned adjacent to a front face of said head, said notch being V shaped, said blade being complementary to and coupled within said notch;
said front face of said head being tapered proximate to said lower edge of said nose, said blade comprising a front cutting edge defining a puncture tip positioned proximate to said lower edge of said nose and said front face of said head;
a cover hingedly coupled to said handle proximate to said first end, said cover being complementary to said head, wherein said head is insertable into said cover with a lower limit of said cover extending past said blade;
a pair of cutouts, each said cutout being positioned in a respective opposing wall of said cover, said cutouts being arcuate, each said cutout being positioned in a respective said opposing wall adjacent to said lower limit of said cover and substantially equally distant from a back end and a front end of said cover;
a biaser operationally coupled to said cover, wherein said biaser is positioned to motivate said cover to a closed position such that said blade is not exposed,
a channel extending through said handle proximate to said first end and a back of said handle;
a pair of penetrations, each said penetration being positioned through a respective said opposing wall of said cover proximate to said back end of said cover, said penetrations being complementary to said channel;
a pin complementary to and positioned through said channel and said pair of penetrations, wherein said cover is hingedly coupled to said head;
said biaser comprising a torsion spring positioned in said channel and coupled to said pin, wherein said cover is positioned such that opening of said cover rotates said pin and induces torsion in said torsion spring such that said torsion spring is motivated to return said cover to a closed position wherein said cover is positioned with said lower limit of said cover extending past said lower edge of said nose;
a stop coupled to said second end of said handle, wherein said stop is positioned on said handle to deter slippage of a user's hand from said handle;
a grip coupled to said handle, said grip extending from said second end to proximate to said first end of said handle, wherein said grip is positioned on said handle to facilitate grasping of said handle in the user's hand, said grip comprising rubber, said grip being textured.
